(19) United States
(12) Patent Application Publication
(10) Pub. No.: US 2019/0347499 A1
(43) Pub. Date: Nov. 14, 2019

(54) DRIVER STATE ESTIMATION DEVICE AND DRIVER STATE ESTIMATION METHOD

(71) Applicant: OMRON Corporation, Kyoto-shi, KYOTO (JP)

(72) Inventors: Yukiko YANAGAWA, Kyoto-shi (JP); Tadashi HYUGA, Kyoto-shi (JP); Tomoyoshi AIZAWA, Kyoto-shi (JP); Koichi KINOSHITA, Kyoto-shi (JP)

(73) Assignee: OMRON Corporation, Kyoto-shi, KYOTO (JP)

(21) Appl. No.: 16/481,666

(22) PCT Filed: Jul. 27, 2017
(86) PCT No.: PCT/JP2017/027244

§ 371 Date: Jul. 29, 2019

(30) Foreign Application Priority Data
Mar. 14, 2017 (JP) 2017-048502

(51) Int. Cl. G06K 9/00; G06T 7/70; G06T 7/50

(52) U.S. Cl. CPC G06K 9/00845; G06T 7/70; G06T 7/50; B60W 40/08; G06T 2207/30201; G06T 2207/30268; G06K 9/00228

(57) ABSTRACT

A driver state estimation device, which can precisely estimate a head position of a driver in the real world from an image, includes a monocular camera for picking up an image including a face of a driver, and a CPU including a head center position estimating section for estimating a head center position of the driver in the image using a three-dimensional face shape model fitted on the face of the driver in the image picked up by the monocular camera, and a distance estimating section for estimating a distance between an origin point located in a front direction of the driver's seat and a head center position of the driver in the real world, on the basis of the head center position of the driver in the image estimated and information including a specification and a position posture of the monocular camera.

### TECHNICAL FIELD

The present invention relates to a driver state estimation device and a driver state estimation method, and more particularly, to a driver state estimation device and a driver state estimation method, whereby a state of a driver such as a head position of the driver and a face direction thereof with respect to the front of a vehicle, can be estimated.

### BACKGROUND ART

Techniques of detecting a state of a driver's motion or line of sight from images of the driver taken by an in-vehicle camera so as to present information required by the driver or give an alarm have been developed through the years.

In an automatic vehicle operation system the development of which has been recently promoted, it is considered that a technique of continuously estimating whether a driver is in a state of being able to conduct a driving operation comes to be necessary even during an automatic vehicle operation, for smooth switching from the automatic vehicle operation to a manual vehicle operation. The development of techniques of analyzing images picked up by an in-vehicle camera to estimate a state of a driver is proceeding.

In order to estimate the state of the driver, techniques of detecting a head position and a face direction of the driver are required. For example, in Patent Document 1, a technique wherein a face area of a driver in an image picked up by an in-vehicle camera is detected, and on the basis of the detected face area, a head position of the driver is estimated, is disclosed.

In the above method for estimating the head position of the driver, specifically, an angle of the head position with respect to the in-vehicle camera is detected. As a method for detecting said angle of the head position, a center position of the face area on the image is detected. Regarding said detected center position of the face area as the head position (a center position of the head), a head position line which passes through said center position of the face area is obtained, and an angle of said head position line (the angle of the head position with respect to the in-vehicle camera) is determined.

Thereafter, a head position on the head position line is detected. As a method for detecting said head position on the head position line, a standard size of the face area in the case of being a prescribed distance away from the in-vehicle camera is previously stored. By comparing this standard size to the size of the actually detected face area, a distance from the in-vehicle camera to the head position is obtained. A position on the head position line away from the in-vehicle camera by the obtained distance is estimated to be the head position.

In a method for estimating a face direction of a driver described in Patent Document 1, feature points (each part of the face) are detected in a face image, and on the basis of displacements between these actually detected feature points and feature points in the case of facing to the front, the face direction of the driver is estimated.

### Problems to be Solved by the Invention

In the method for estimating the head position described in Patent Document 1, the head position (the center position of the head) on the image is detected with reference to the center position of the face area. However, the center position of the face area varies according to a face direction. Therefore, even in cases where the center position of the head is at the same position, with different face directions, the center position of the face area (the head position) detected on each image is detected at a different position. As a result, the head position detected on the image is detected at a position different from the head position in the real world, that is, the head position in the real world cannot be accurately estimated.

As to a driver's seat of a vehicle, generally its position is rearwardly and forwardly adjustable. When an in-vehicle camera is mounted diagonally to the front of the driver's seat, for example, even if the driver is facing to the front, with different longitudinal positions of the driver's seat, that is, with different head positions of the driver, the face directions (angles) of the driver photographed by the in-vehicle camera are detected differently. Specifically, when the driver's seat is positioned a little forward, the face direction (angle) of the driver photographed by the in-vehicle camera is detected as larger than when the driver's seat is positioned a little rearward. Thus, by the face direction estimation method described in Patent Document 1, it is impossible to deal with different face directions (angles) of the driver photographed by the in-vehicle camera which vary with different longitudinal positions of the driver's seat (different head positions of the driver). Even the face direction of the driver with respect to the front of the vehicle cannot be correctly detected.

### PRIOR ART DOCUMENT

### Patent Document

Patent Document 1: Japanese Patent Application Laid-Open Publication No. 2014-218140

### SUMMARY OF THE INVENTION

### Means for Solving Problem and the Effect

The present invention was developed in order to solve the above problems, and it is an object of the present invention to provide a driver state estimation device and a driver state estimation method, whereby a head position of a driver in the real world can be precisely estimated from an image without being affected by different face directions of the driver or different positions of a driver's seat.

In order to achieve the above object, a driver state estimation device according to a first aspect of the present invention is characterized by estimating a state of a driver from a picked-up image, said driver state estimation device comprising:

a monocular imaging section for picking up an image including a face of a driver sitting in a driver's seat; and

at least one hardware processor,

said at least one hardware processor comprising

a head center position estimating section for estimating a head center position of the driver in the image, using a three-dimensional face shape model fitted on the face of the driver in the image picked up by the imaging section, and

a distance estimating section for estimating a distance between an origin point located in a front direction of the driver's seat and a head center position of the driver in the real world, on the basis of the head center position of the driver in the image estimated by the head center position estimating section, and information including a specification and a position posture of the imaging section.

Using the driver state estimation device according to the first aspect of the present invention, since the head center position of the driver in the image is estimated using the three-dimensional face shape model fitted on the face of the driver in the image, the head center position of the driver in the image can be estimated with precision, regardless of different face directions of the driver. Since the head center position of the driver in the image can be estimated with precision, on the basis of said head center position, and the information including the specification (an angle of view, resolution, etc.) and the position posture (an angle, a distance from the origin point, etc.) of the imaging section, the distance between the origin point located in the front direction of the driver's seat and the head center position of the driver in the real world can be estimated with precision.

The driver state estimation device according to a second aspect of the present invention is characterized by the at least one hardware processor, in the driver state estimation device according to the first aspect of the present invention, comprising

a driving operation possibility deciding section for deciding whether the driver is in a state of being able to conduct a driving operation with use of the distance estimated by the distance estimating section.

Using the driver state estimation device according to the second aspect of the present invention, on the basis of the distance estimated by the distance estimating section, whether the driver is in the state of being able to conduct a driving operation can be decided. For example, when the origin point is set to be at a steering wheel position, on the basis of the distance, whether the driver is within a range of reaching the steering wheel can be decided, leading to appropriate monitoring of the driver.

The driver state estimation device according to a third aspect of the present invention is characterized by the at least one hardware processor, in the driver state estimation device according to the first or second aspect of the present invention, comprising

a face direction detecting section for detecting a face direction of the driver with respect to the imaging section from the image picked up by the imaging section,

an angle estimating section for estimating an angle formed by a direction of the imaging section from the head center position of the driver in the real world and the front direction of the driver's seat, on the basis of the head center position of the driver in the image estimated by the head center position estimating section, and the information including the specification and the position posture of the imaging section, and

a face direction estimating section for estimating a face direction of the driver with reference to the front direction of the driver's seat, on the basis of the face direction of the driver detected by the face direction detecting section, and the angle estimated by the angle estimating section.

Using the driver state estimation device according to the third aspect of the present invention, on the basis of the precisely estimated head center position of the driver in the image, and the information including the specification (the angle of view, resolution, etc.) and the position posture (the angle) of the imaging section, the angle formed by the direction of the imaging section from the head center position of the driver in the real world and the front direction of the driver's seat can be estimated with precision. With use of said estimated angle, without being affected by different positions of the driver's seat (different head positions of the driver) or different face directions of the driver, the face direction of the driver with reference to the front direction of the driver's seat can be precisely estimated from the face direction of the driver with respect to the imaging section.

The driver state estimation device according to a fourth aspect of the present invention is characterized by the at least one hardware processor, in the driver state estimation device according to the third aspect of the present invention, comprising a driver state deciding section for deciding a state of the driver, on the basis of the face direction of the driver estimated by the face direction estimating section.

Using the driver state estimation device according to the fourth aspect of the present invention, on the basis of the face direction of the driver estimated by the face direction estimating section, the state of the driver, for example, the looking-aside state thereof can be decided with precision, leading to appropriate monitoring of the driver.

A driver state estimation method according to a first aspect of the present invention is characterized by using a device comprising a monocular imaging section for picking up an image including a face of a driver sitting in a driver's seat, and

at least one hardware processor,

estimating a state of the driver with use of the image picked up by the imaging section,

the at least one hardware processor conducting the steps comprising:

estimating a head center position of the driver in the image, using a three-dimensional face shape model fitted on the face of the driver in the image picked up by the imaging section; and

estimating a distance between an origin point located in a front direction of the driver's seat and a head center position of the driver in the real world, on the basis of the head center position of the driver in the image estimated in the step of estimating the head center position, and information including a specification and a position posture of the imaging section.

Using the driver state estimation method according to the first aspect of the present invention, without being affected by different positions of the driver's seat (different head positions of the driver) or different face directions of the driver, the distance between the origin point located in the front direction of the driver's seat and the head center position of the driver in the real world can be estimated. It becomes possible to use said estimated distance for deciding whether the driver is in a state of being able to conduct a driving operation.

The driver state estimation method according to a second aspect of the present invention is characterized by the at least one hardware processor, in the driver state estimation method according to the first aspect of the present invention, conducting the steps comprising:

detecting a face direction of the driver with respect to the imaging section from the picked-up image;

estimating an angle formed by a direction of the imaging section from the head center position of the driver in the real world and the front direction of the driver's seat, on the basis of the head center position of the driver in the image estimated in the step of estimating the head center position, and the information including the specification and the position posture of the imaging section; and

estimating a face direction of the driver with reference to the front direction of the driver's seat, on the basis of the face direction of the driver detected in the step of detecting the face direction, and the angle estimated in the step of estimating the angle.

Using the driver state estimation method according to the second aspect of the present invention, without being affected by different positions of the driver's seat (different head positions of the driver) or different face directions of the driver, the face direction of the driver with reference to the front direction of the driver's seat can be estimated with precision from the face direction of the driver with respect to the imaging section.

### BRIEF DESCRIPTION OF DRAWINGS

FIG. 1 is a block diagram schematically showing the principal part of an automatic vehicle operation system including a driver state estimation device according to an embodiment of the present invention;

FIG. 2 is a block diagram showing a construction of the driver state estimation device according to the embodiment;

FIG. 3 is a plan view of a car room for illustrating a driver state estimation method according to an embodiment;

FIG. 4 consists of illustrations for explaining the relationship between a center position of a head in an image estimated by the driver state estimation device according to the embodiment and a position of a driver's seat;

FIG. 5 consists of illustrations for explaining the relationship between the center position of the head in the image estimated by the driver state estimation device according to the embodiment and a face direction of the driver, and the like; and

FIG. 6 is a flowchart showing processing operations conducted by a processor in the driver state estimation device according to the embodiment.

### MODE FOR CARRYING OUT THE INVENTION

The embodiments of the driver state estimation device and the driver state estimation method according to the present invention are described below by reference to the Figures. The below-described embodiments are preferred embodiments of the present invention, and various technical limitations are included. However, the scope of the present invention is not limited to these modes, as far as there is no description particularly limiting the present invention in the following explanations.

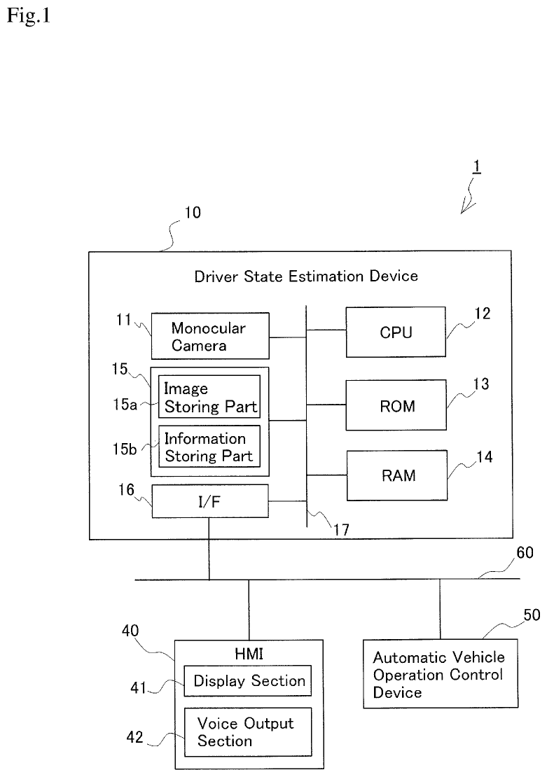

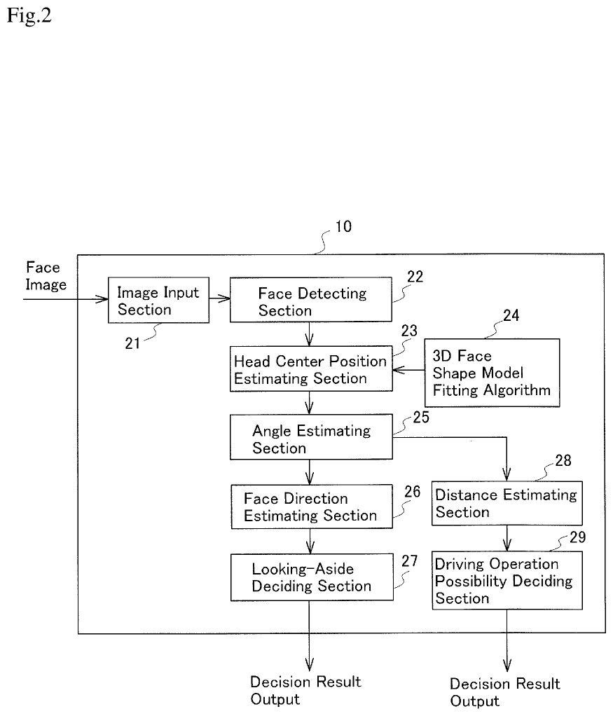

FIG. 1 is a block diagram schematically showing the principal part of an automatic vehicle operation system including a driver state estimation device according to an embodiment. FIG. 2 is a block diagram showing a construction of the driver state estimation device according to the embodiment.

An automatic vehicle operation system 1 is a system for allowing a vehicle to automatically cruise along a road, comprising a driver state estimation device 10, an HMI (Human Machine Interface) 40, and an automatic vehicle operation control device 50, each of which is connected through a communication bus 60. To the communication bus 60, various kinds of sensors and control devices (not shown) required for controlling an automatic vehicle operation and a manual vehicle operation by a driver are also connected.

The driver state estimation device 10 conducts processing of estimating a state of a driver, specifically, a face direction of the driver with reference to a front direction of a driver's seat from a picked-up image and processing of estimating a distance from a steering wheel position to a head center position of the driver, and thereafter, conducts processing of deciding the state of the position and attitude of the driver based on these estimation results so as to output these decision results, and the like.

The driver state estimation device 10 comprises a monocular camera 11, a CPU 12, a ROM 13, a RAM 14, a storage section 15, and an input/output interface (I/F) 16, each of which is connected through a communication bus 17.

The monocular camera 11 as an imaging section can periodically (e.g. 30-60 times/sec) pick up images including a face of the driver sitting in the driver's seat, and comprises a monocular lens system, an imaging element such as a CCD or a CMOS, an infrared irradiation unit such as a near infrared LED which irradiates near infrared light (none of them shown), and associated parts.

The CPU 12 is a hardware processor, which reads out a program stored in the ROM 13, and based on said program, performs various kinds of processing on image data acquired from the monocular camera 11. A plurality of CPUs 12 may be mounted.

In the ROM 13, programs for allowing the CPU 12 to perform processing as a face detecting section 22, a head center position estimating section 23, an angle estimating section 25, a face direction estimating section 26, a looking-aside deciding section 27, a distance estimating section 28, and a driving operation possibility deciding section 29 shown in FIG. 2, a three-dimensional (3D) face shape model fitting algorithm 24, and the like are stored. All or part of the programs performed by the CPU 12 may be stored in the storage section 15 or a storing medium (not shown) other than the ROM 13.

In the RAM 14, data required for various kinds of processing performed by the CPU 12, programs read from the ROM 13, and the like are temporarily stored.

The storage section 15 comprises an image storing part 15a for storing image data picked up by the monocular camera 11, and an information storing part 15b for storing specification information such as an angle of view and the number of pixels (width×length) of the monocular camera 11, and position posture information such as a mounting position and a mounting angle of the monocular camera 11. The CPU 12 may perform processing of allowing the image storing part 15a, being a part of the storage section 15, to store image data picked up by the monocular camera 11 (storage instruction), and processing of reading the image from the image storing part 15a (reading instruction). As to the position posture information such as the mounting position and the mounting angle of the monocular camera 11, for example, a setting menu of the monocular camera 11 may be constructed in such a manner that can be read by the HMI 40, so that when mounting the monocular camera 11, the setting thereof can be previously selected in the setting menu. The storage section 15 comprises one or more non-volatile semiconductor memories such as an EEPROM or a flash memory. The input/output interface (I/F) 16 is used for exchanging data with various kinds of external units through the communication bus 60.

Based on signals sent from the driver state estimation device 10, the HMI 40 performs processing of informing the driver of the state thereof such as a looking-aside state or a driving attitude, processing of informing the driver of an operational situation of the automatic vehicle operation system 1 or release information of the automatic vehicle operation, processing of outputting an operation signal related to automatic vehicle operation control to the automatic vehicle operation control device 50, and the like. The HMI 40 comprises, for example, a display section 41 mounted at a position easy to be viewed by the driver, a voice output section 42, and an operating section and a voice input section, neither of them shown.

The automatic vehicle operation control device 50 is also connected to a power source control unit, a steering control unit, a braking control unit, a periphery monitoring sensor, a navigation system, a communication unit for communicating with the outside, and the like, none of them shown. Based on information acquired from each of these units, control signals for conducting the automatic vehicle operation are output to each control unit so as to conduct automatic cruise control (such as automatic steering control and automatic speed regulation control) of the vehicle.

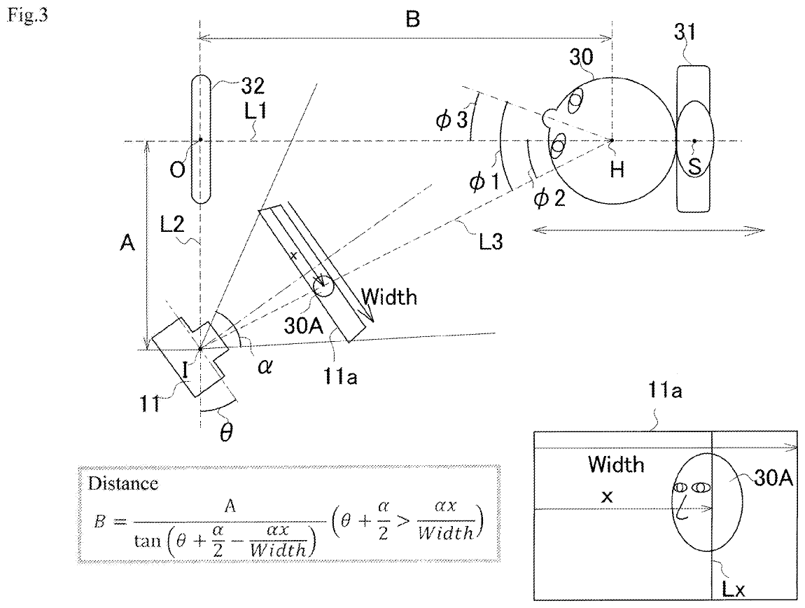

Before explaining each section of the driver state estimation device 10 shown in FIG. 2, a driver state estimation method using the driver state estimation device 10 is described below by reference to FIGS. 3-5.

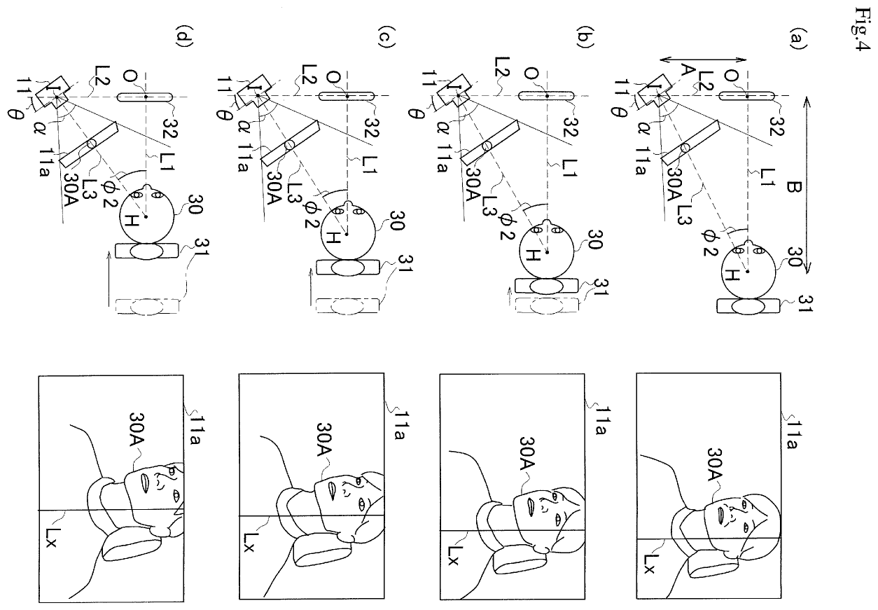

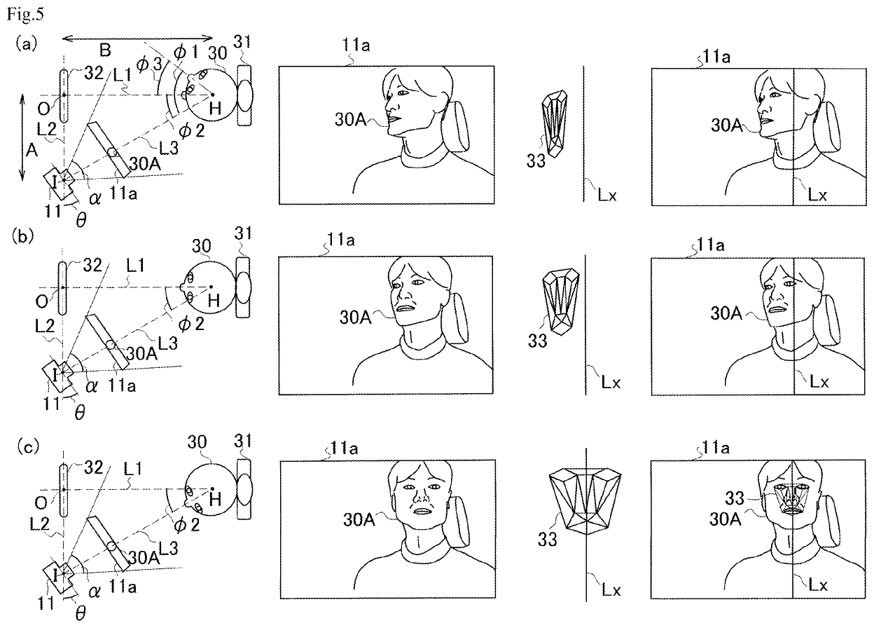

FIG. 3 is a plan view of a car room for explaining a driver state estimation method using the driver state estimation device 10. FIG. 4 consists of illustrations for explaining the relationship between a head center position in an image estimated by the driver state estimation device 10 and a position of a driver's seat, and the like. FIG. 5 consists of illustrations for explaining the relationship between the head center position in the image estimated by the driver state estimation device 10 and a face direction of the driver, and the like.

As shown in FIG. 3, it is a situation in which a driver 30 is sitting in a driver's seat 31. A steering wheel 32 is located in front of the driver's seat 31, and the position of the driver's seat 31 can be rearwardly and forwardly adjusted. The monocular camera 11 is mounted diagonally to the left front of the driver's seat 31, in such a manner that images including a face of the driver can be picked up. The mounting position posture of the monocular camera 11 is not limited to this embodiment.

In this embodiment, when a center position of the steering wheel 32 is represented by an origin point O, a line segment connecting between the origin point O and a seat center S is represented by L1, and a line segment crossing the line segment 1 at right angles at the origin point O is represented by L2, a mounting angle of the monocular camera 11 is set to be an angle θ with respect to the line segment L2, and a distance between an imaging surface center I of the monocular camera 11 and the origin point O is set to be A. A head center position H of the driver 30 in the real world is regarded as being on the line segment L1. The origin point O is the apex of a right angle of a right triangle having the hypotenuse of a line segment L3 which connects between the monocular camera 11 and the head center position H of the driver 30 in the real world. The position of the origin point O may be other than the center position of the steering wheel 32.

An angle of view of the monocular camera 11 is represented by α, while the number of pixels in the width direction of an image 11a is represented by Width. A head center position (the number of pixels in the width direction) of a driver 30A in the image 11a is represented by x, and a line segment (a perpendicular line) indicating the head center position x of the driver 30A in the image 11a is represented by Lx.

In the following descriptions, a face direction (angle) of the driver 30 in the real world with respect to the monocular camera 11 is represented by ϕ1, an angle formed by a direction of the monocular camera 11 from the head center position H of the driver 30 (line segment L3) and a front direction of the driver's seat 31 (line segment L1) is represented by ϕ2, and a face direction (angle) of the driver 30 with reference to the front direction of the driver's seat 31 (line segment L1) is represented by ϕ3.

In the driver state estimation device 10, the head center position x of the driver 30A in the picked-up image 11a is estimated by performing fitting processing of a below-described three-dimensional face shape model.

When the head center position x of the driver 30A can be estimated, with use of the known information, that is, the specification (angle of view α, pixel number in the width direction Width) of the monocular camera 11, and the position posture (mounting angle θ, distance A from the origin point O) thereof, the angle ϕ2 (the angle formed by the line segments L3 and L1) can be obtained by the below-described Equation 1. When strictly taking into consideration the lens distortion of the monocular camera 11 and the like, calibration is performed using inside parameters.

$$\begin{matrix}φ 2 = 90 ° - ( ( 90 °–θ ) - α / 2 + α \times x / Width ) \\ = θ + α / 2 - α \times x / Width\end{matrix} \qquad Equation 1$$

With use of the face direction (angle ϕ1) of the driver 30 with respect to the monocular camera 11 obtained by the below-described fitting processing of the three-dimensional face shape model, by calculating Equation 2: angle ϕ1−angle ϕ2, the face direction (angle) ϕ3 of the driver 30 with reference to the front direction of the driver's seat 31 (line segment L1) can be obtained.

By obtaining the angle ϕ2, which varies according to the position (the longitudinal position) of the driver's seat 31, that is, the head position of the driver 30, and correcting the angle ϕ1 (the face direction with respect to the monocular camera 11) with use of this angle ϕ2, it becomes possible to obtain an accurate face direction (angle) ϕ3 of the driver 30 with reference to the front direction of the driver's seat 31 (line segment L1), regardless of the position of the driver's seat 31.

If the angle ϕ2 can be obtained, since a triangle formed by connecting the origin point O, the imaging surface center I, and the head center position H becomes a right triangle whose apex of the right angle is the origin point O, a distance B from the head center position H of the driver 30 to the origin point O (the steering wheel 32) can be estimated by the following Equation 3, with use of the known distance A from the origin point O to the imaging surface center I, and the angle ϕ2. With use of the estimated distance B, it becomes possible to decide whether the driver 30 is in a state of being able to operate the steering wheel (is within a range where he/she can operate the steering wheel).

B=A/tan ϕ2 Equation 3:
(here, ϕ2=θ+α/2−α×x/Width)
(where θ+α/2>α×x/Width)

FIGS. 4(a)-4(d) show the relationship between plan views of the car room when the position of the driver's seat 31 is moved forward in stages and the images 11a picked up by the monocular camera 11. In any figure, the driver 30 faces to the front of the vehicle. In each of the images 11a, the head center position x of the driver 30A in the image 11a is represented by the line segment Lx.

As the driver's seat 31 is moved forward, the face direction (angle) ϕ1 of the driver 30 with respect to the monocular camera 11 becomes larger and larger. Therefore, with only the angle ϕ1, whether the driver 30 is facing to the front of the vehicle cannot be grabbed correctly.

On the other hand, as the driver's seat 31 is moved forward, the head center position H of the driver 30 in the real world also moves forward, and the line segment Lx indicating the head center position x of the driver 30A in the image 11a moves toward the left in the image 11a. As the line segment Lx indicating the head center position x in the image 11a moves toward the left, the angle ϕ2 (the angle formed by the line segments L3 and L1) becomes larger.

Accordingly, when obtaining the face direction (angle) ϕ3 of the driver 30 with reference to the front direction of the driver's seat 31 (line segment L1) by calculating the above Equation 2: angle ϕ1−angle ϕ2, the value of the angle ϕ3=ϕ1−ϕ2 is about 0° in this case. It becomes possible to estimate that the driver 30 is facing to the front of the vehicle at any seat position.

And by the above Equation 3, with use of the known distance A from the origin point O to the imaging surface center I and the angle ϕ2, it also becomes possible to estimate the distance B from the head center position H of the driver 30 to the origin point O (the steering wheel).

FIGS. 5(a)-5(c) show plan views of the car room in cases where the driver's seat 31 is at the same position while the face direction of the driver 30 varies, images 11a picked up by the monocular camera 11, three-dimensional face shape models 33 to be fitted on said images 11a and the line segments Lx indicating the head center position x, and images showing the head center position x of the driver 30A estimated by the fitting processing of the three-dimensional face shape model 33 to the image 11a using the line segment Lx.

FIG. 5(a) shows a case where the face direction of the driver 30 is the right with respect to the front direction of the vehicle. FIG. 5(b) shows a case where the face direction of the driver 30 is the front of the vehicle. FIG. 5(c) shows a case where the face direction of the driver 30 is the left with respect to the front direction of the vehicle.

As shown in the images 11a of FIGS. 5(a)-5(c), the positions of organ points such as the eyes, nose and mouth on the face of the driver 30A change according to the face direction, while the head center position x (line segment Lx) does not change according to the face direction. Here, in cases where the driver's seat 31 is at the same position, the head center position x (line segment Lx) is almost the same without any difference (deviation) caused by the distinction of sex (male or female) or physical features of the driver 30.

When the driver 30 turns his/her face, the face direction (angle) ϕ1 of the driver 30 with respect to the monocular camera 11 changes. Therefore, with only the angle ϕ1, to which direction the driver 30 is facing cannot be grabbed correctly.

On the other hand, even when the driver 30 turns his/her face, the head center position H of the driver 30 in the real world and the position of the line segment Lx indicating the head center position x of the driver 30A in the image 11a hardly change. Consequently, the angle ϕ2 (the angle formed by the line segments L3 and L1) obtained by the above Equation 1 is almost the same value, even if the driver 30 turns his/her face.

As a result, by calculating the above Equation 2: angle ϕ1−angle ϕ 2 to obtain the face direction (angle) ϕ3 of the driver 30 with reference to the front direction of the driver's seat 31 (line segment L1), it becomes possible to almost accurately estimate the face direction (angle) of the driver 30 with respect to the front direction of the driver's seat 31. And by the above Equation 3, with use of the known distance A from the origin point O to the imaging surface center I and the angle ϕ2, it also becomes possible to estimate the distance B from the head center position H of the driver 30 to the origin point O (the steering wheel).

A specific construction of the driver state estimation device 10 is described below by reference to the block diagram shown in FIG. 2.

The driver state estimation device 10 is established as a device wherein various kinds of programs stored in the ROM 13 are read into the RAM 14 and conducted by the CPU 12, so as to perform processing as an image input section 21, the face detecting section 22, head center position estimating section 23, three-dimensional (3D) face shape model fitting algorithm 24, angle estimating section 25, face direction estimating section 26, looking-aside deciding section 27, distance estimating section 28, and driving operation possibility deciding section 29.

The image input section 21 reads image data including the face of the driver picked up by the monocular camera 11 from the image storing part 15a, and captures it into the RAM 14.

The face detecting section 22 detects the face of the driver from the image picked up by the monocular camera 11. The method for detecting the face from the image is not particularly limited, but a method for detecting the face at a high speed and with high precision should be adopted. For example, by regarding a contrast difference (a luminance difference) or edge intensity of local regions of the face, and the relevance (the cooccurrence) between these local regions as feature quantities so as to learn by combining these feature quantities large in number, a detector is prepared. And such detector having a hierarchical structure (a hierarchical structure from a hierarchy in which the face is roughly captured to a hierarchy in which the minute portions of the face are captured) makes it possible to detect the regions of the face at a high speed. In order to deal with the face direction or inclination, a plurality of detectors which are allowed to learn separately according to the face direction or inclination may be mounted.

The head center position estimating section 23 allows the three-dimensional face shape model 33 (see FIG. 5) to fit on the face of the driver 30A in the image 11a (fitting), and estimates the head center position x of the driver 30A in the image 11a using said fitted three-dimensional face shape model 33. As a technique of fitting a three-dimensional face shape model on a face of a person in an image, the techniques described in the Japanese Patent Application Laid-Open Publication No. 2007-249280, the Japanese Patent Publication No. 4501937, and the like may be preferably used, but it is not limited to these techniques.

An example of the technique of fitting a three-dimensional face shape model on a face of a driver in an image is described in outline below.

In previous learning processing, acquisition of a three-dimensional face shape model, sampling by a retina structure, and acquisition of an error estimate matrix by a canonical correlation analysis are conducted, and the learning results from these learning operations (the error estimate matrix, normalization parameters, etc.) are previously stored in the three-dimensional face shape model fitting algorithm 24 within the ROM 13.

The three-dimensional face shape model is created by inputting feature organ points of face organs such as the outer corners of the eyes, the inner corners of the eyes, both ends of the nostrils and both ends of the lips to face images of a large number of persons, and connecting between mean three-dimensional coordinates of those points. On every feature organ point, in order to enhance the detection precision of the feature organ point, the sampling by the retina structure is conducted. The retina structure is a mesh sampling structure which is radiationally and discretely (like a range of points which are tighter as approaching the center thereof, while looser with distance from the center thereof) arranged around the target feature organ point.

In cases where a horizontal axis is represented by an X axis, a vertical axis is represented by a Y axis, and a depth (longitudinal) axis is represented by a Z axis when the face is seen from the front, the three-dimensional face shape model can be freely transformed using a plurality of parameters such as a rotation on the X axis (pitch), a rotation on the Y axis (yaw), a rotation on the Z axis (roll), and scaling,

The error estimate matrix is a learning result on a correlation indicating in which direction the position of every feature organ point of the three-dimensional face shape model located at an incorrect position (a different position from the position of the feature organ point to be detected) should be corrected (a transformation matrix from feature quantities at the feature organ points to change quantities of the parameters from the correct position).

As a method for acquiring the error estimate matrix, deformation parameters (correct model parameters) of a three-dimensional face shape model at a correct position (a correct model) are prepared, and a displacement model which is made by displacing the correct model parameters using random numbers and the like within a fixed range is created. By dealing with sampling feature quantities acquired based on the displacement model and differences between the displacement model and the correct model (change quantities of the parameters) as one set, the error estimate matrix is acquired as a learning result on the correlation.

The fitting processing of the three-dimensional face shape model 33 on the face of the driver 30A in the image 11a is described. On the basis of the result of face detection by the face detecting section 22, the three-dimensional face shape model 33 is initially placed at an appropriate position to the position, direction and size of the face. The positions of feature organ points at the initial position thereof are detected, and feature quantities at the feature organ points are calculated. The feature quantities are input to the error estimate matrix, and change quantities of deformation parameters into the neighborhood of the correct position are calculated. To the deformation parameters of the three-dimensional face shape model 33 at the present position, the above-calculated change quantities of the deformation parameters into the neighborhood of the correct position are added. By these operations, the three-dimensional face shape model 33 is fitted into the neighborhood of the correct position on the image at a high speed. The above method for controlling a three-dimensional face shape model is called Active Structured Appearance Model (ASAM).

The use of the three-dimensional face shape model 33 makes it possible not only to obtain the positions and shapes of the organs of the face, but also to directly obtain the attitude of the face with respect to the monocular camera 11, that is, to which direction the face is facing and the angle ϕ1.

From the three-dimensional face shape model 33, the head center position in three dimensions, for example, a center position (a central axis) of a sphere when the head is supposed to be said sphere, is estimated, and by projecting it on the two-dimensional image 11a, the head center position x of the driver 30A in the image 11a is estimated. As a method for projecting a head center position in three dimensions on a two-dimensional plane, various kinds of methods such as a parallel projection method, or perspective projection methods such as one-point perspective projection may be adopted.

The angle estimating section 25, on the basis of the head center position x of the driver 30A in the image 11a estimated by the head center position estimating section 23, and the information including the specification (angle of view α and pixel number in the width direction Width) and the position posture (angle θ) of the monocular camera 11 stored in the information storing part 15b, estimates the angle ϕ2 formed by the direction of the monocular camera 11 from the head center position H of the driver 30 in the real world (line segment L3) and the front direction of the driver's seat 31 (line segment L1) using the above Equation 1 (ϕ2=θ+α/2−α×x/Width).

The face direction estimating section 26, on the basis of the face direction (angle ϕ1) of the driver detected in the detecting processing by the face detecting section 22, or the three-dimensional face shape model fitting processing by the head center position estimating section 23, and the angle ϕ2 estimated by the angle estimating section 25, estimates the face direction (angle ϕ3=ϕ1−ϕ2) of the driver 30 with reference to the front direction of the driver's seat 31 (line segment L1 passing through the origin point O).

The looking-aside deciding section 27, on the basis of the face direction (angle ϕ3) of the driver 30 estimated by the face direction estimating section 26, for example, reads an angle range in which the driver is not in a looking-aside state stored in the ROM 13 or the information storing part 15b into the RAM 14, and conducts a comparison operation so as to decide whether the driver is in the looking-aside state. A signal indicating said decision result is output to the HMI 40 and the automatic vehicle operation control device 50.

The distance estimating section 28, on the basis of the head center position x of the driver 30A in the image 11a estimated by the head center position estimating section 23, and the information including the specification (angle of view α and pixel number in the width direction Width) and the position posture (angle θ and distance A) of the monocular camera 11 (in other words, angle ϕ2 and distance A) stored in the information storing part 15b, estimates the distance B between the origin point O located in the front direction of the driver's seat 31 and the head center position H of the driver 30 in the real world using the above Equation 3 (B=A/tan ϕ2).

The driving operation possibility deciding section 29, on the basis of the distance B estimated by the distance estimating section 28, decides whether the driver 30 is in a state of being able to perform a driving operation. For example, it reads a range in which the steering wheel can be properly operated stored in the ROM 13 or the information storing part 15b into the RAM 14, and performs a comparison operation so as to decide whether the driver 30 is within a range of reaching the steering wheel 32. A signal indicating said decision result is output to the HMI 40 and the automatic vehicle operation control device 50.

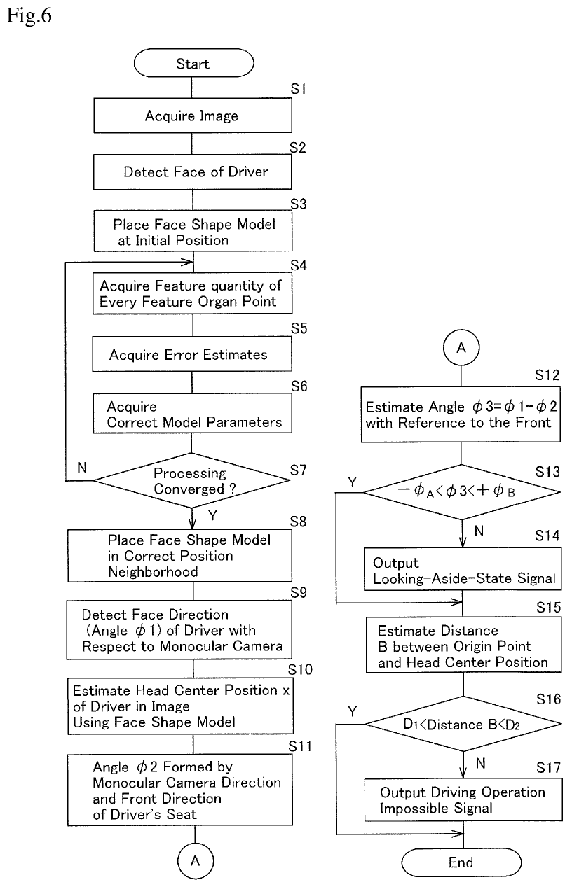

FIG. 6 is a flowchart showing processing operations which the CPU 12 performs in the driver state estimation device 10 according to the embodiment. The monocular camera 11 picks up, for example, 30-60 frames of image per second, and this processing is conducted on every frame or frames at regular intervals.

In step S1, data of the image 11a (including the face of the driver) picked up by the monocular camera 11 is acquired from the image storing part 15a, and in step S2, from the acquired image 11a, the face (the face area, face direction, etc.) of the driver 30A is detected.

In step S3, at an appropriate position (an initial position) to the detected position of the face in the image 11a, the three-dimensional face shape model 33 is placed. In step S4, the position of every feature organ point at the initial position is obtained, and based on the retina construction, the feature quantity of every feature organ point is acquired.

In step S5, the acquired feature quantities are input to the error estimate matrix, and error estimates between the three-dimensional face shape model 33 and the correct model parameters are acquired. In step S6, to the deformation parameters of the three-dimensional face shape model 33 at the present position, the above error estimates are added so as to acquire estimated values of the correct model parameters.

In step S7, whether the acquired correct model parameters are within a normal range and the processing converged, is judged. When it is judged that the processing has not converged in step S7, the operation returns to step S4, wherein the feature quantity of every feature organ point of a new three-dimensional face shape model 33 created based on the acquired correct model parameters is acquired. On the other hand, when it is judged that the processing converged in step S7, the operation goes to step S8, wherein the placement of the three-dimensional face shape model 33 in the neighborhood of the correct position is completed.

In step S9, from similarity conversion (parallel displacement, rotation) parameters included in the parameters of the three-dimensional face shape model 33 placed in the neighborhood of the correct position, the face direction (angle ϕ1) of the driver 30 with respect to the monocular camera 11 is obtained. A right-hand angle with respect to the monocular camera 11 is indicated with a sign + (plus), while a left-hand angle is indicated with a sign − (minus).

In step S10, using the three-dimensional face shape model 33, the head center position x of the driver 30A in the image 11a is obtained. For example, from the three-dimensional face shape model 33, the head center position in three dimensions (supposing that the head is a sphere, a center position of said sphere) is estimated, and it is projected on the two-dimensional image 11a so as to estimate the head center position x of the driver 30A in the image 11a.

In step S11, on the basis of the head center position x of the driver 30A in the image 11a estimated in step S9, and the information including the specification (angle of view α and pixel number in the width direction Width) and the position posture (angle θ) of the monocular camera 11, the angle ϕ2 formed by the direction of the monocular camera 11 from the head center position H of the driver 30 in the real world (line segment L3) and the front direction of the driver's seat 31 (line segment L1) is estimated using the above Equation 1.

In step S12, the face direction (angle ϕ3) of the driver 30 with reference to the front direction of the driver's seat 31 (the origin point O) is estimated. Specifically, a difference between the face direction (angle ϕ1) of the driver 30 with respect to the monocular camera 11 obtained in step S9 and the angle ϕ2 (the angle formed by line segments L3 and L1) estimated in step S11 (ϕ1−ϕ2) is obtained. A right-hand angle with respect to the front direction of the driver's seat 31 (the origin point O) is indicated with a sign + (plus), while a left-hand angle is indicated with a sign − (minus).

In step S13, by reading out an angle range of a not-looking-aside state stored in the RAM 13 or the information storing part 15b so as to conduct a comparison operation, whether the angle ϕ3 is within the angle range of the not-looking-aside state (−ϕ_{A}<ϕ3<+ϕ_{B}) is decided. The angles −ϕ_{A} and +ϕ_{B} are angles which allow a decision that the driver is in the looking-aside state. In step S13, when it is decided that the driver is not in the looking-aside state (the angle is within the range −ϕ_{A}<ϕ3<+ϕ_{B}), the operation goes to step S15. On the other hand, when it is decided that the driver is in the looking-aside state (the angle is not within the range −ϕ_{A}<ϕ3<+ϕ_{B}), the operation goes to step S14.

In step S14, a looking-aside-state signal is output to the HMI 40 and the automatic vehicle operation control device 50.

The HMI 40, when the looking-aside-state signal is input thereto, for example, performs a looking-aside alarm display on the display section 41, and a looking-aside alarm announcement by the voice output section 42. The automatic vehicle operation control device 50, when the looking-aside-state signal is input thereto, for example, performs speed reduction control.

In step S15, the distance B between the origin point O located in the front direction of the driver's seat 31 and the head center position H of the driver 30 in the real world is estimated using the above Equation 3 (B=A/tan ϕ2).

In step S16, by reading out a range wherein the steering wheel can be appropriately operated stored in the RAM 13 or the information storing part 15b so as to conduct a comparison operation, whether the distance B is within the range wherein the steering wheel can be appropriately operated (distance D₁<distance B<distance D₂) is decided. For example, the distances D₁ and D₂ can be set to be about 40 cm and 70 cm, respectively. In step S16, when it is decided that the distance B is within the range wherein the steering wheel can be appropriately operated, the processing is ended. On the other hand, when it is decided that the distance B is not within the range wherein the steering wheel can be appropriately operated, the operation goes to step S17.

In step S17, a driving operation impossible signal is output to the HMI 40 and the automatic vehicle operation control device 50, and thereafter, the processing is ended. The HMI 40, when the driving operation impossible signal is input thereto, for example, performs a display giving an alarm about the driving attitude or seat position on the display section 41, and an announcement giving an alarm about the driving attitude or seat position by the voice output section 42. The automatic vehicle operation control device 50, when the driving operation impossible signal is input thereto, for example, performs speed reduction control. Here, the order of the operations in steps S12-S14 and the operations in steps S15-S17 may be altered. Or with different timing with the passage of time, the operations in steps S12-S14 and the operations in steps S15-S17 may be separately performed.

Since the driver state estimation device 10 according to the embodiment estimates the head center position x of the driver 30A in the image 11a using the three-dimensional face shape model 33 fitted on the face of the driver 30A in the image 11a, as described by reference to FIG. 5, the head center position x of the driver 30A in the image 11a can be accurately estimated, regardless of different face directions of the driver 30.

Since the head center position x of the driver 30A in the image 11a can be accurately estimated, on the basis of the head center position x, and the known information about the specification (angle of view α and pixel number in the width direction Width) and the position posture (angle θ) of the monocular camera 11, the angle ϕ2 formed by the direction of the monocular camera 11 from the head center position H of the driver 30 in the real world (line segment L3) and the front direction of the driver's seat 31 (line segment L1 passing through the origin point O) can be precisely estimated.

And with use of the angle ϕ2, without being affected by different positions of the driver's seat 31 (different head positions of the driver 30) and different face directions of the driver 30, from the face direction of the driver 30 with respect to the monocular camera 11 (angle ϕ1), the face direction of the driver 30 (angle ϕ3) with reference to the front direction of the driver's seat 31 (the origin point O) can be precisely estimated.

On the basis of the face direction of the driver 30 (angle ϕ3) estimated by the face direction estimating section 26, the state of the driver 30 in the real world, for example, the looking-aside state thereof can be precisely decided.

On the basis of the head center position x of the driver 30A in the image 11a estimated by the head center position estimating section 23, and the known information about the specification (angle of view α and pixel number in the width direction Width) and the position posture (angle θ, distance A from the origin point O, etc.) of the monocular camera 11, the distance B between the origin point O located in the front direction of the driver's seat 31 and the head center position H of the driver 30 in the real world can be precisely estimated. And on the basis of the distance B estimated by the distance estimating section 28, whether the driver 30 is within the range wherein he/she can appropriately operate the steering wheel can be decided.

Using the driver state estimation device 10, without mounting another sensor in addition to the monocular camera 11, the above-described distance B to the driver and the face direction (angle ϕ3) thereof can be accurately estimated, leading to a simplification of the device construction. And because of no need to mount another sensor as mentioned above, additional operations accompanying the mounting thereof are not necessary, leading to a reduction of loads on the CPU 12, minimization of the device, and cost reduction.

By mounting the driver state estimation device 10 on the automatic vehicle operation system 1, it becomes possible to allow the driver to appropriately monitor the automatic vehicle operation. Even if a situation in which cruising control by automatic vehicle operation is hard occurs, switching to manual vehicle operation can be swiftly and safely conducted, resulting in enhancement of safety of the automatic vehicle operation system 1.

(Addition 1)

A driver state estimation device for estimating a state of a driver from a picked-up image, comprising:

a monocular imaging section for picking up an image including a face of a driver sitting in a driver's seat;

at least one storage section; and

at least one hardware processor,

the at least one storage section comprising

an image storing part for storing the image picked up by the imaging section, and

an information storing part for storing information including a specification and a position posture of the imaging section, and

the at least one hardware processor comprising

a storage instructing section for allowing the image storing part to store the image picked up by the imaging section,

a reading instructing section for reading the image from the image storing part,

a head center position estimating section for estimating a head center position of the driver in the image, using a three-dimensional face shape model fitted on the face of the driver in the image read from the image storing part, and

a distance estimating section for estimating a distance between an origin point located in a front direction of the driver's seat and a head center position of the driver in the real world, on the basis of the head center position of the driver in the image estimated by the head center position estimating section and the information including the specification and the position posture of the imaging section read from the information storing part.

(Addition 2)

A driver state estimation method for, by using a device comprising

a monocular imaging section for picking up an image including a face of a driver sitting in a driver's seat,

at least one storage section, and

at least one hardware processor,

estimating a state of the driver with use of the image picked up by the imaging section,

the at least one storage section comprising:

an image storing part for storing the image picked up by the imaging section; and

an information storing part for storing information including a specification and a position posture of the imaging section, and

the at least one hardware processor conducting the steps comprising:

storage instructing for allowing the image storing part to store the image picked up by the imaging section;

reading the image from the image storing part;

estimating a head center position of the driver in the image, using a three-dimensional face shape model fitted on the face of the driver in the image read from the image storing part; and

estimating a distance between an origin point located in a front direction of the driver's seat and a head center position of the driver in the real world, on the basis of the head center position of the driver in the image estimated in the step of estimating the head center position, and the information including the specification and the position posture of the imaging section read from the information storing part.

### INDUSTRIAL APPLICABILITY

The present invention may be widely applied to an automatic vehicle operation system in which a state of a driver need be monitored, and the like, chiefly in the field of automobile industry.

### DESCRIPTION OF REFERENCE SIGNS

10: Driver state estimation device
11: Monocular camera
11a: Image
12: CPU
13: ROM
14: RAM
15: Storage section
15a: Image storing part
15b: Information storing part
21: Image input section
22: Face detecting section
23: Head center position estimating section
24: Three-dimensional face shape model fitting algorithm
25: Angle estimating section
26: Face direction estimating section
27: Looking-aside deciding section
28: Distance estimating section
29: Driving operation possibility deciding section
30: Driver in the real world
30A: Driver in the image
31: Driver's seat
32: Steering wheel
Lx: Line segment (indicating the head center position x in the image)
O: Origin point
S: Seat center
H: Head center position of the driver in the real world
I: Imaging surface center
L1, L2, L3: Line segment
α: Angle of view
θ: Mounting angle of monocular camera

1. A driver state estimation device for estimating a state of a driver from a picked-up image, comprising:
a monocular imaging section for picking up an image including a face of a driver sitting in a driver's seat; and
at least one hardware processor,
the at least one hardware processor comprising
a head center position estimating section for estimating a head center position of the driver in the image, using a three-dimensional face shape model fitted on the face of the driver in the image picked up by the imaging section, and
a distance estimating section for estimating a distance between an origin point located in a front direction of the driver's seat and a head center position of the driver in the real world, on the basis of the head center position of the driver in the image estimated by the head center position estimating section, and information including a specification and a position posture of the imaging section.

2. The driver state estimation device according to claim 1, wherein
the at least one hardware processor comprises
a driving operation possibility deciding section for deciding whether the driver is in a state of being able to conduct a driving operation with use of the distance estimated by the distance estimating section.

3. The driver state estimation device according to claim 1, wherein
the at least one hardware processor comprises
a face direction detecting section for detecting a face direction of the driver with respect to the imaging section from the image picked up by the imaging section,
an angle estimating section for estimating an angle formed by a direction of the imaging section from the head center position of the driver in the real world and the front direction of the driver's seat, on the basis of the head center position of the driver in the image estimated by the head center position estimating section, and the information including the specification and the position posture of the imaging section, and
a face direction estimating section for estimating a face direction of the driver with reference to the front direction of the driver's seat, on the basis of the face direction of the driver detected by the face direction detecting section, and the angle estimated by the angle estimating section.

4. The driver state estimation device according to claim 3, wherein
the at least one hardware processor comprises
a driver state deciding section for deciding a state of the driver, on the basis of the face direction of the driver estimated by the face direction estimating section.

5. A driver state estimation method for, by using a device comprising
a monocular imaging section for picking up an image including a face of a driver sitting in a driver's seat, and
at least one hardware processor,
estimating a state of the driver with use of the image picked up by the imaging section,
the at least one hardware processor conducting the steps comprising:
estimating a head center position of the driver in the image, using a three-dimensional face shape model fitted on the face of the driver in the image picked up by the imaging section; and
estimating a distance between an origin point located in a front direction of the driver's seat and a head center position of the driver in the real world, on the basis of the head center position of the driver in the image estimated in the step of estimating the head center position, and information including a specification and a position posture of the imaging section.

6. The driver state estimation method according to claim 5, wherein
the at least one hardware processor conducts the steps comprising:
detecting a face direction of the driver with respect to the imaging section from the picked-up image;
estimating an angle formed by a direction of the imaging section from the head center position of the driver in the real world and the front direction of the driver's seat, on the basis of the head center position of the driver in the image estimated in the step of estimating the head center position, and the information including the specification and the position posture of the imaging section; and
estimating a face direction of the driver with reference to the front direction of the driver's seat, on the basis of the face direction of the driver detected in the step of detecting the face direction, and the angle estimated in the step of estimating the angle.

7. The driver state estimation device according to claim 2, wherein
the at least one hardware processor comprises
a face direction detecting section for detecting a face direction of the driver with respect to the imaging section from the image picked up by the imaging section,
an angle estimating section for estimating an angle formed by a direction of the imaging section from the head center position of the driver in the real world and the front direction of the driver's seat, on the basis of the head center position of the driver in the image estimated by the head center position estimating section, and the information including the specification and the position posture of the imaging section, and
a face direction estimating section for estimating a face direction of the driver with reference to the front direction of the driver's seat, on the basis of the face direction of the driver detected by the face direction detecting section, and the angle estimated by the angle estimating section.

8. The driver state estimation device according to claim 7, wherein
the at least one hardware processor comprises
a driver state deciding section for deciding a state of the driver, on the basis of the face direction of the driver estimated by the face direction estimating section.
